(19) United States
(12) Patent Application Publication
(10) Pub. No.: US 2024/0152357 A1
(43) Pub. Date: May 9, 2024

(54) Programmable Logic Device-Based Software-Defined Vector Engines

(71) Applicant: Altera Corporation, San Jose, CA (US)

(72) Inventor: Chidamber Kulkarni, Richmond (CA)

(21) Appl. No.: 18/398,688

(22) Filed: Dec. 28, 2023

(51) Int. Cl. G06F 9/30

(52) U.S. Cl. CPC G06F 9/30036; G06F 9/3001; G06F 9/30098

(57) ABSTRACT

Circuitry, systems, and methods are provided for an integrated circuit device including a programmable logic fabric. The programmable logic fabric is configured to implement software-defined vector engines. The programmable logic fabric also includes a data movement engine (DME) that uses multiple DME threads to programmably insert data within an interior of the software-defined vector engines.

### BACKGROUND

The present disclosure relates to software-defined vector engines that are implemented using programmable logic devices.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it may be understood that these statements are to be read in this light, and not as admissions of prior art.

With the proliferation of artificial technology (AI), vector databases (VectorDB) are becoming increasingly widely used. The amount of databases that support VectorDB features continue to increase. Traditional databases are designed for organizing and searching for (structured) text data. As more and more of the new data that is created tends to be either image, audio, or video data, conventional methods of organizing and retrieving data may be or may become insufficient. Vector DBs are one step to address this need for organizing and retrieving non-text data from databases.

Vector DBs use vector embeddings to store the data that represents the original object (e.g. image, audio, or video). The vector embedding is generated using a pre-trained neural network or similar systems. The queries to find similar objects are then run on these vector embeddings. Input data (e.g., images) are converted into vectors that are then indexed in RAM. A query to search for similar images then performs a vector similarity search across all the vectors that are stored in the RAM.

Similarity may be determined using any suitable technique such as Euclidean distance or cosine similarity searching. The similarity search using Euclidean distance will involve calculating the minimum distance between the input vector and the vectors in the database (in RAM). Note that the resulting search can have more than one value depending on the acceptable distance between vectors and how many fall within a minimal distance criterion.

Many VectorDBs deploy a CPU implementation of the similarity determination algorithms. This involves performing a calculation of vector distances between input (query) vector and all the other vectors in the database (in RAM). The optimizations used mostly involve modifying the implementation to use x86 AVX instructions to benefit from SIMD vector operations. Both the algorithms exhibit data parallelism at multiple levels. There are also GPU-based acceleration of these algorithms. However, such techniques may not fully utilize the capabilities of programmable logic devices to enhance performance in similarity searches that have substantial parallelism.

### BRIEF DESCRIPTION OF THE DRAWINGS

Various aspects of this disclosure may be better understood upon reading the following detailed description and upon reference to the drawings in which:

FIG. 1 is a block diagram of a system used to program an integrated circuit device, in accordance with an embodiment of the present disclosure;

FIG. 2 is a block diagram of the integrated circuit device of FIG. 1, in accordance with an embodiment of the present disclosure;

FIG. 3 is a block diagram of programmable fabric of the integrated circuit device of FIG. 1, in accordance with an embodiment of the present disclosure;

FIG. 4 is a block diagram of an FPGA-implemented vector engine system, in accordance with an embodiment of the present disclosure;

FIG. 5 is a block diagram of an FPGA-implemented vector engine system having an arithmetic operator and a multiplier, in accordance with an embodiment of the present disclosure;

FIG. 6 is a block diagram of an FPGA-implemented vector engine system having the arithmetic operator and the multiplier of FIG. 5 with additional registers, multiplexers, and a data movement engine, in accordance with an embodiment of the present disclosure;

FIG. 7 is a block diagram of a scaled-out implementation of the FPGA-implemented vector engine system of FIG. 6, in accordance with an embodiment of the present disclosure; and

FIG. 8 is a block diagram of a data processing system that may incorporate the integrated circuit device of FIG. 1, in accordance with an embodiment of the present disclosure.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

As previously noted, VectorDBs may be desirable for use in AI implementations. As discussed below, a vector engine template may be realized in a programmable logic device using an optimized programmable logic implementation (e.g., that includes placement restraints, maximum frequency optimizations, etc.). The programmable logic implementation may also use a programmable data movement engine-based framework that enables mapping of vector similarity search algorithms of one or more such vector engines. The programmable data movement engine-based framework relies on a high level design tool that can generate the programming instructions for an ensemble of data movement engines to harness parallelism at multiple levels. These implementations enable efficient implementation of vector similarity search algorithms without reprogramming the programmable logic device once it is configured. The implementations also enable a high level design entry and a design flow to express the vector similarity search algorithms thereby reducing time to market for new products/designs.

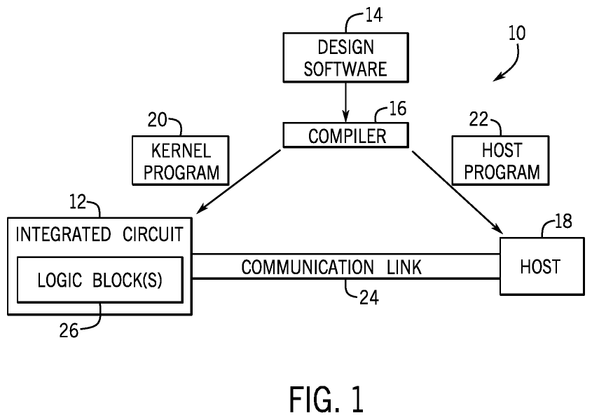

With the foregoing in mind, FIG. 1 is a block diagram of a system 10 that may implement one or more functionalities. For example, a designer may desire to implement functionality, such as the operations of this disclosure, on an integrated circuit device 12 (e.g., a programmable logic device, such as a field programmable gate array (FPGA) or an application specific integrated circuit (ASIC)). In some cases, the designer may specify a high-level program to be implemented, such as an OpenCL® program or SYCL®, which may enable the designer to more efficiently and easily provide programming instructions to configure a set of programmable logic cells for the integrated circuit device 12 without specific knowledge of low-level hardware description languages (e.g., Verilog or VHDL). For example, since OpenCL® is quite similar to other high-level programming languages, such as C++, designers of programmable logic familiar with such programming languages may have a reduced learning curve than designers that are required to learn unfamiliar low-level hardware description languages to implement new functionalities in the integrated circuit device 12. Additionally or alternatively, a subset of the high-level program may be implemented using and/or translated to a lower level language, such as a register-transfer language (RTL).

The designer may implement high-level designs using design software 14, such as a version of INTEL® QUARTUS® by INTEL CORPORATION. The design software 14 may use a compiler 16 to convert the high-level program into a lower-level description. In some embodiments, the compiler 16 and the design software 14 may be packaged into a single software application. The compiler 16 may provide machine-readable instructions representative of the high-level program to a host 18 and the integrated circuit device 12. The host 18 may receive a host program 22 which may be implemented by the kernel programs 20. To implement the host program 22, the host 18 may communicate instructions from the host program 22 to the integrated circuit device 12 via a communications link 24, which may be, for example, direct memory access (DMA) communications or peripheral component interconnect express (PCIe) communications. In some embodiments, the kernel programs 20 and the host 18 may enable configuration of a logic block 26 on the integrated circuit device 12. The logic block 26 may include circuitry and/or other logic elements and may be configured to implement arithmetic operations, such as addition and multiplication.

The designer may use the design software 14 to generate and/or to specify a low-level program, such as the low-level hardware description languages described above. For example, the design software 14 may be used to map a workload to one or more routing resources of the integrated circuit device 12 based on a timing, a wire usage, a logic utilization, and/or a routability. Additionally or alternatively, the design software 14 may be used to route first data to a portion of the integrated circuit device 12 and route second data, power, and clock signals to a second portion of the integrated circuit device 12. Further, in some embodiments, the system 10 may be implemented without a host program 22 and/or without a separate host program 22. Moreover, in some embodiments, the techniques described herein may be implemented in circuitry as a non-programmable circuit design. Thus, embodiments described herein are intended to be illustrative and not limiting.

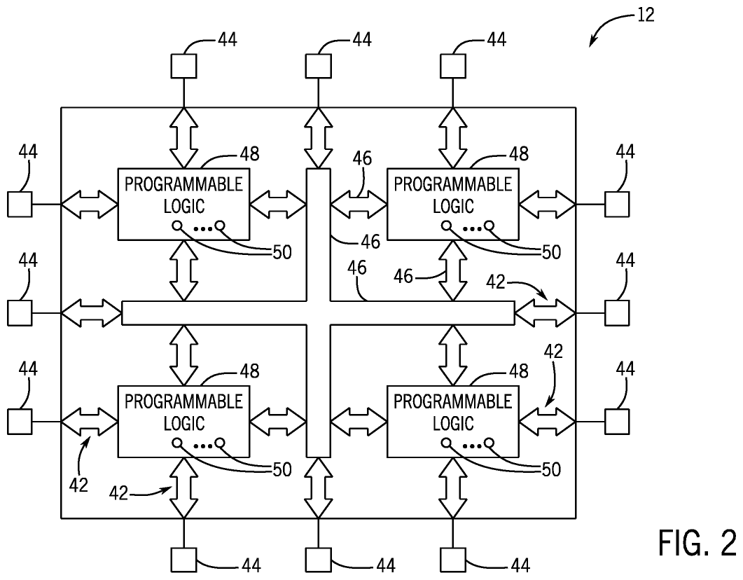

Turning now to a more detailed discussion of the integrated circuit device 12, FIG. 2 is a block diagram of an example of the integrated circuit device 12 as a programmable logic device, such as a field-programmable gate array (FPGA). Further, although referred to as an FPGA throughout this disclosure, it should be understood that the integrated circuit device 12 may be any other suitable type of programmable logic device (e.g., a structured ASIC such as eASIC™ by Intel Corporation ASIC and/or application-specific standard product). The integrated circuit device 12 may have input/output circuitry 42 for driving signals off the device and for receiving signals from other devices via input/output pins 44. Interconnection resources 46, such as global and local vertical and horizontal conductive lines and buses, and/or configuration resources (e.g., hardwired couplings, logical couplings not implemented by designer logic), may be used to route signals on integrated circuit device 12. Additionally, interconnection resources 46 may include fixed interconnects (conductive lines) and programmable interconnects (i.e., programmable connections between respective fixed interconnects). For example, the interconnection resources 46 may be used to route signals, such as clock or data signals, through the integrated circuit device 12. Additionally or alternatively, the interconnection resources 46 may be used to route power (e.g., voltage) through the integrated circuit device 12. Programmable logic 48 may include combinational and sequential logic circuitry. For example, programmable logic 48 may include look-up tables, registers, and multiplexers. In various embodiments, the programmable logic 48 may be configured to perform a custom logic function. The programmable interconnects associated with interconnection resources may be considered to be a part of programmable logic 48.

Programmable logic devices, such as the integrated circuit device 12, may include programmable elements 50 with the programmable logic 48. In some embodiments, at least some of the programmable elements 50 may be grouped into logic array blocks (LABs). As discussed above, a designer (e.g., a user, a customer) may (re)program (e.g., (re)configure) the programmable logic 48 to perform one or more desired functions. By way of example, some programmable logic devices may be programmed or reprogrammed by configuring programmable elements 50 using mask programming arrangements, which is performed during semiconductor manufacturing. Other programmable logic devices are configured after semiconductor fabrication operations have been completed, such as by using electrical programming or laser programming to program the programmable elements 50. In general, programmable elements 50 may be based on any suitable programmable technology, such as fuses, anti-fuses, electrically programmable read-only-memory technology, random-access memory cells, mask-programmed elements, and so forth.

Many programmable logic devices are electrically programmed. With electrical programming arrangements, the programmable elements 50 may be formed from one or more memory cells. For example, during programming, configuration data is loaded into the memory cells using input/output pins 44 and input/output circuitry 42. In one embodiment, the memory cells may be implemented as random-access-memory (RAM) cells. The use of memory cells based on RAM technology as described herein is intended to be only one example. Further, since these RAM cells are loaded with configuration data during programming, they are sometimes referred to as configuration RAM cells (CRAM). These memory cells may each provide a corresponding static control output signal that controls the state of an associated logic component in programmable logic 48. In some embodiments, the output signals may be applied to the gates of metal-oxide-semiconductor (MOS) transistors within the programmable logic 48.

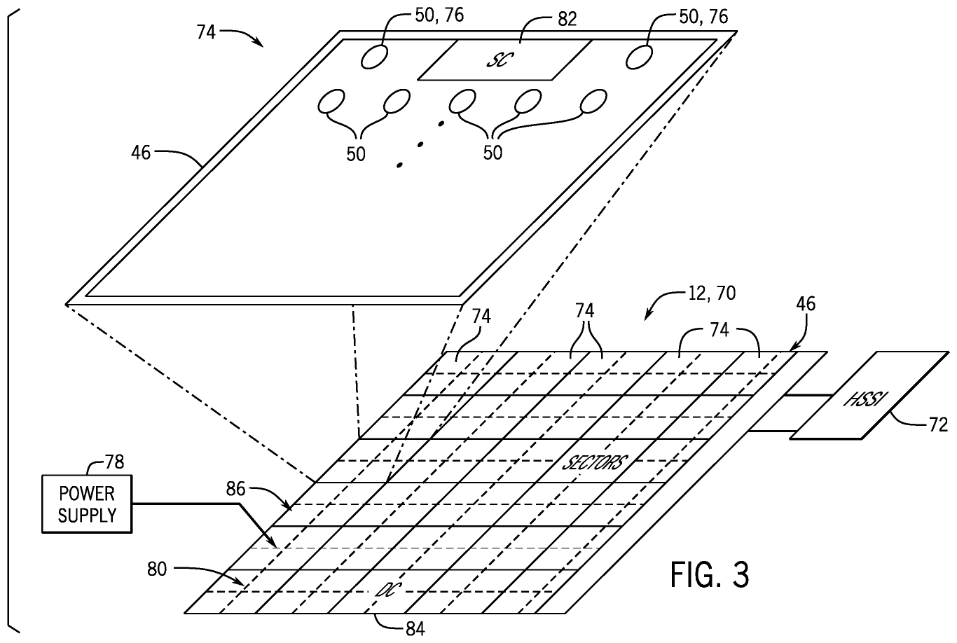

The integrated circuit device 12 may include any programmable logic device such as a field programmable gate array (FPGA) 70, as shown in FIG. 3. For the purposes of this example, the FPGA 70 is referred to as a FPGA, though it should be understood that the device may be any suitable type of programmable logic device (e.g., an application-specific integrated circuit and/or application-specific standard product). In one example, the FPGA 70 is a sectorized FPGA of the type described in U.S. Patent Publication No. 2016/0049941, “Programmable Circuit Having Multiple Sectors,” which is incorporated by reference in its entirety for all purposes. The FPGA 70 may be formed on a single plane. Additionally or alternatively, the FPGA 70 may be a three-dimensional FPGA having a base die and a fabric die of the type described in U.S. Pat. No. 10,833,679, “Multi-Purpose Interface for Configuration Data and Designer Fabric Data,” which is incorporated by reference in its entirety for all purposes.

In the example of FIG. 3, the FPGA 70 may include transceiver 72 that may include and/or use input/output circuitry, such as input/output circuitry 42 in FIG. 2, for driving signals off the FPGA 70 and for receiving signals from other devices. Interconnection resources 46 may be used to route signals, such as clock or data signals, through the FPGA 70. The FPGA 70 is sectorized, meaning that programmable logic resources may be distributed through a number of discrete programmable logic sectors 74. Programmable logic sectors 74 may include a number of programmable elements 50 having operations defined by configuration memory 76 (e.g., CRAM). A power supply 78 may provide a source of voltage (e.g., supply voltage) and current to a power distribution network (PDN) 80 that distributes electrical power to the various components of the FPGA 70. Operating the circuitry of the FPGA 70 causes power to be drawn from the power distribution network 80.

There may be any suitable number of programmable logic sectors 74 on the FPGA 70. Indeed, while 29 programmable logic sectors 74 are shown here, it should be appreciated that more or fewer may appear in an actual implementation (e.g., in some cases, on the order of 50, 100, 500, 1000, 5000, 10,000, 50,000 or 100,000 sectors or more). Programmable logic sectors 74 may include a sector controller (SC) 82 that controls operation of the programmable logic sector 74. Sector controllers 82 may be in communication with a device controller (DC) 84.

Sector controllers 82 may accept commands and data from the device controller 84 and may read data from and write data into its configuration memory 76 based on control signals from the device controller 84. In addition to these operations, the sector controller 82 may be augmented with numerous additional capabilities. For example, such capabilities may include locally sequencing reads and writes to implement error detection and correction on the configuration memory 76 and sequencing test control signals to effect various test modes.

The sector controllers 82 and the device controller 84 may be implemented as state machines and/or processors. For example, operations of the sector controllers 82 or the device controller 84 may be implemented as a separate routine in a memory containing a control program. This control program memory may be fixed in a read-only memory (ROM) or stored in a writable memory, such as random-access memory (RAM). The ROM may have a size larger than would be used to store only one copy of each routine. This may allow routines to have multiple variants depending on “modes” the local controller may be placed into. When the control program memory is implemented as RAM, the RAM may be written with new routines to implement new operations and functionality into the programmable logic sectors 74. This may provide usable extensibility in an efficient and easily understood way. This may be useful because new commands could bring about large amounts of local activity within the sector at the expense of only a small amount of communication between the device controller 84 and the sector controllers 82.

Sector controllers 82 thus may communicate with the device controller 84, which may coordinate the operations of the sector controllers 82 and convey commands initiated from outside the FPGA 70. To support this communication, the interconnection resources 46 may act as a network between the device controller 84 and sector controllers 82. The interconnection resources 46 may support a wide variety of signals between the device controller 84 and sector controllers 82. In one example, these signals may be transmitted as communication packets.

The use of configuration memory 76 based on RAM technology as described herein is intended to be only one example. Moreover, configuration memory 76 may be distributed (e.g., as RAM cells) throughout the various programmable logic sectors 74 of the FPGA 70. The configuration memory 76 may provide a corresponding static control output signal that controls the state of an associated programmable element 50 or programmable component of the interconnection resources 46. The output signals of the configuration memory 76 may be applied to the gates of metal-oxide-semiconductor (MOS) transistors that control the states of the programmable elements 50 or programmable components of the interconnection resources 46.

The programmable elements 50 of the FPGA 40 may also include some signal metals (e.g., communication wires) to transfer a signal. In an embodiment, the programmable logic sectors 74 may be provided in the form of vertical routing channels (e.g., interconnects formed along a y-axis of the FPGA 70) and horizontal routing channels (e.g., interconnects formed along an x-axis of the FPGA 70), and each routing channel may include at least one track to route at least one communication wire. If desired, communication wires may be shorter than the entire length of the routing channel. That is, the communication wire may be shorter than the first die area or the second die area. A length L wire may span L routing channels. As such, a length of four wires in a horizontal routing channel may be referred to as “H4” wires, whereas a length of four wires in a vertical routing channel may be referred to as “V4” wires.

As discussed above, some embodiments of the programmable logic fabric may be configured using indirect configuration techniques. For example, an external host device may communicate configuration data packets to configuration management hardware of the FPGA 70. The data packets may be communicated internally using data paths and specific firmware, which are generally customized for communicating the configuration data packets and may be based on particular host device drivers (e.g., for compatibility). Customization may further be associated with specific device tape outs, often resulting in high costs for the specific tape outs and/or reduced scalability of the FPGA 70.

As previously noted, similarity searches may be performed on Vector DB s using a CPU and/or GPU implementation of the similarity determination algorithms to perform Euclidean distance, cosine distance, and/or any other suitable similarity search techniques. This involves performing a calculation of vector distances between input (query) vectors and all the other vectors in the database (in RAM). The optimizations used mostly involve modifying the implementation to use x86 AVX instructions to benefit from SIMD vector operations. The algorithms exhibit data parallelism at multiple levels.

There are primarily two main levels of concurrency. First, the individual operations over the dimensions of a vector can be done in parallel and second, the distance calculation between input vector and all the other vectors in the database can be calculated independent of each other. Only for the final minimum distance calculation there is some dependency that may be at least partially addressed using partitioning.

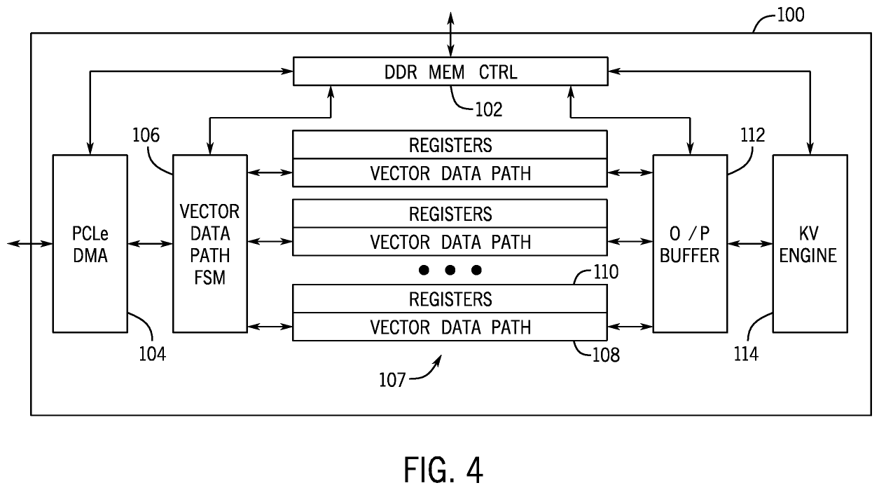

FIG. 4 shows an illustration of an implementation using an FPGA-based acceleration system 100. The FPGA-based acceleration system 100 includes a DDR memory controller 102 that uses a PCIe DMA interface 104 to transfer data. The FPGA-based acceleration system 100 includes a Vector Data Path finite state machine (FSM) 106 that controls data movement through vector engine space 107. The vector engine space 107 includes vector data paths 108 that may be used to move data in, out, and/or around in the vector engines in the vector engine space 107. The vector engine space 107 may also include registers 110 used to store data in the vector engine space 107. The FPGA-based acceleration system 100 also includes a buffer 112 that may store data to be input to and/or output from the vector engine space 107. The FPGA-based acceleration system 100 also includes a key-value engine (KV Engine) 114 that stores vector physical addresses using hashing. The FPGA-based acceleration system 100 may perform faster (e.g., 5-7 times faster) than a CPU/GPU-based solution (e.g., with a 500 MHz implementation).

There are two levels of parallelism in these operations. The first level of parallelism involves data parallelism at the operations within the vector dimension, and the second level of parallelism is between different vectors themselves. Intra-vector parallelism may be exploited using a SIMD vector engine like an AVX engine. In a programmable fabric-based implementation (FPGA-based acceleration system 100), the fabric lends itself to create multiple variants that can be chosen at design time that best suits a particular implementation.

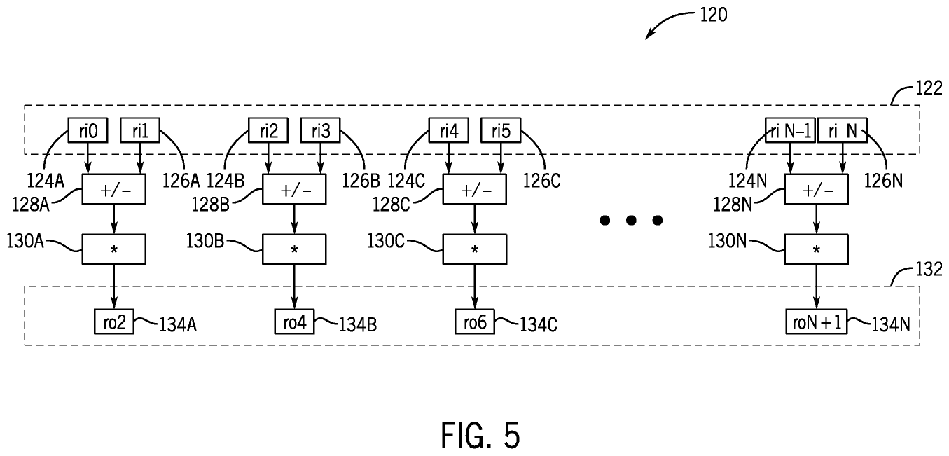

For instance, there may be vector engines implemented in programmable logic, such as the vector engine system 120 of FIG. 5. The vector engine system 120 includes input registers 122 that store data to be used in the vector engine system 120. For instance, the vector engines of the vector engine system 120 may include a pair of input registers 124 and 126. For instance, a first vector engine may include input registers 124A and 126A, a second vector engine may include input registers 124B and 126B, a third vector engine may include input registers 124C and 126C, and so on until a last vector engine may include input registers 124N and 126N. The vector engines also include respective arithmetic logic units (ALUs) 128 (individually referred to as ALUs 128A, 128B, 128C, and 128N). The ALUs 128 may be full ALUs or at least ALU-like and capable to perform addition and subtraction of values stored in respective input registers 124 and 126. The vector engines also include respective multipliers 130 (individually referred to as multipliers 130A, 130B, 130C, and 130N). The vector engine system 120 also includes output registers 132 (individually referred to as output registers 134A, 134B, 134C, and 134N) for output from the respective vector engines.

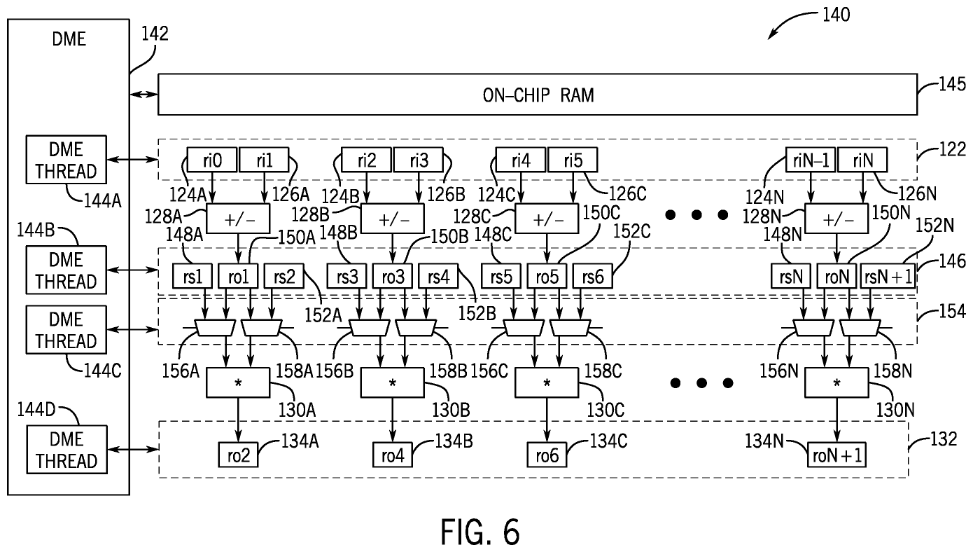

To add additional flexibility suitable for vector engine-based processing, the vector engine system 120 may be supplemented with additional circuitry to improve flexibility and/or processing. For instance, FIG. 6 shows a vector engine system 140 that is similar to the vector engine system 120 of FIG. 5 except that the vector engine system 140 includes a data movement engine (DME) 142 driving multiple DME threads 144 (individually referred to as DME threads 144A, 144B, 144C, and 144D).

There are primarily four main operations supported by the vector engines: add, subtract, multiply, and square. In addition, there may be at least three main data types supported including float16, float32, bfloat16, and/or any other number formats (e.g., INT8) suitable to address common vector similarity search algorithms that may account for a majority of the computations in the vector engines. Additional operations, such as minimum, division, and the like may also be implemented. However, in some embodiments, these additional operations may be outside of the main loop of the computational similarity seeking algorithms as they are performed once (or only few times) unlike the repetitive operations that are performed numerous (e.g., millions of) times.

The vector engine system 140 may also include on-chip RAM 125 and additional registers 146. For instance, the additional registers 146 may include registers 148, 150, and 152. Registers 150 (respectively referred to as registers 150A, 150B, 150C, and 150N) for the illustrated vector engines are used to receive an output from a respective ALU 128. The registers 148 (respectively referred to as registers 148A, 148B, 148C, and 148N) and the registers 152 (respectively referred to as registers 152A, 152B, 152C, and 152N) for the illustrated vector engines provide an ability for a DME thread (e.g., DME thread 144B) to inject data into the registers 148 and/or 152 for use in the respective vector engine. The vector engine system 140 also includes multiplexers 154 (respectively referred to as multiplexers 156A, 156B, 156C, 156N, 158A, 158B, 158C, and 158N) for the illustrated respective vector engines. The additional registers 146 and multiplexers 154 provide the flexibility of the vector engine system 140 to move data between vector engines and/or vector engine elements to realize different combinations of operations found in the vector similarity search algorithms. The sets of registers 146 and the sets of multiplexers 154 are programmable such that a data movement engine can copy the registers to/from the on-chip RAM 125. In some embodiments, hard DSP blocks in FPGA devices may be used to realize this architecture with some additional supporting circuitry.

There are two types of DME threads 144. One DME thread type (e.g., DME threads 144A, 144B, and 144D) copies data to/from the on-chip RAM 145 to vector engine registers (e.g., registers 122, 132, and/or 146). Another DME thread type (e.g., DME thread 144C) sets the multiplexers 154 to ensure that either the output register (e.g., registers 150A, 150B, 150C, or 150N) from an earlier operation (e.g. addition in ALU 128A, 128B, 128C, or 128N) is forwarded to the input of a next operation (e.g. multiplier 130A, 130B, 130C, or 130D) or the independent input registers 148 or 152 populated by DME thread 144B are used for the next operation. The DME threads 144 may be implemented using a fixed function implemented in the logic fabric of the FPGA with programmable input registers to feed the source and destination addresses of registers and the on-chip RAM 145. For instance, this implementation may be utilized with a micro-coding scheme

Generation of the schedule of operations and physical memory map of data may be calculated at design time by the compiler 16 that has complete knowledge of various lifetimes of variables. Specifically, a cycle accurate orchestration of data movement using the DME threads 144 can be achieved using compile time analysis. As algorithms for vector similarity searching may be somewhat free of run-time data dependencies, they lend themselves to very good static compiler analysis and optimization. This enables a high level of programmability and an ability to leverage an optimization implementation of actual vector engines using physical location constraints to obtain a best maximum frequency and to create templates for different widths (e.g. 32, 64, 128, 1024, or other suitable widths) to match an appropriate implementation template with the DME threads 144 to realize a suitable implementation. Furthermore, the programmable data movement engine framework enables decoupling of optimized operator implementation in the vector engine using compile time analysis to generate a data movement schedule. The data movement schedule may then be implemented using the threads of the data movement engines using microcode.

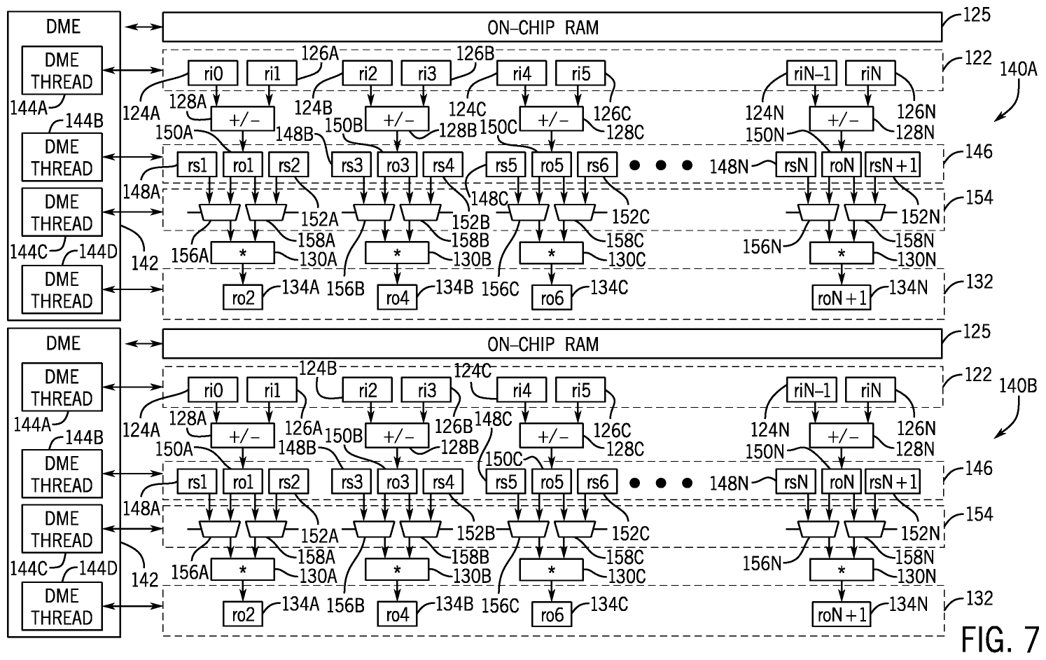

The vector engine system 140 may also be scaled up or down by including more or fewer instances of the design of the vector engines with minimal changes to the design or its performed algorithm due to using a high level design tool (e.g., Quartus) to perform such scaling up or down. For instance, FIG. 7 shows a scaled-out implementation with two vector engine systems 140A and 140B. Both vector engine systems 140A and 140B are instances of the vector engine systems 140 except that the vector engine systems 140A and 140B do not have its own on-chip RAM 125 but share the on-chip RAM 125. The scalability of the vector engine system 140 enables scalability in terms of performance and an ability to trade-off area for performance using compile time analysis.

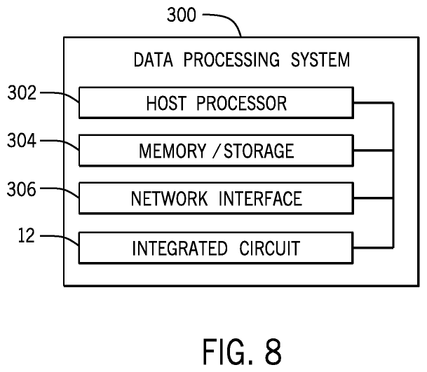

The vector engine systems described with respect to FIGS. 4-7 may be components included in a data processing system, such as a data processing system 300, shown in FIG. 8. The data processing system 300 may include the integrated circuit device 12 including a programmable logic fabric (e.g., FPGA fabric), a host processor 302, memory and/or storage circuitry 304, and a network interface 306. The data processing system 300 may include more or fewer components (e.g., electronic display, user interface structures, application specific integrated circuits (ASICs)). The integrated circuit device 12 may be used to efficiently programmed to snoop a request from the host and prefill a cache with data based on the request to reduce memory access time. That is, the integrated circuit device 12 may accelerate functions of the host, such as the host processor 302. The host processor 302 may include any of the foregoing processors that may manage a data processing request for the data processing system 300 (e.g., to perform encryption, decryption, machine learning, video processing, voice recognition, image recognition, data compression, database search ranking, bioinformatics, network security pattern identification, spatial navigation, cryptocurrency operations, or the like). The memory and/or storage circuitry 304 may include random access memory (RAM), read-only memory (ROM), one or more hard drives, flash memory, or the like. The memory and/or storage circuitry 304 may hold data to be processed by the data processing system 300. In some cases, the memory and/or storage circuitry 304 may also store configuration programs (e.g., bitstreams, mapping function) for programming the FPGA 70 and/or the AFU 200. The network interface 306 may allow the data processing system 300 to communicate with other electronic devices. The data processing system 300 may include several different packages or may be contained within a single package on a single package substrate. For example, components of the data processing system 300 may be located on several different packages at one location (e.g., a data center) or multiple locations. For instance, components of the data processing system 300 may be located in separate geographic locations or areas, such as cities, states, or countries.

The data processing system 300 may be part of a data center that processes a variety of different requests. For instance, the data processing system 300 may receive a data processing request via the network interface 306 to perform encryption, decryption, machine learning, video processing, voice recognition, image recognition, data compression, database search ranking, bioinformatics, network security pattern identification, spatial navigation, digital signal processing, or other specialized tasks.

While the embodiments set forth in the present disclosure may be susceptible to various modifications and alternative forms, specific embodiments have been shown by way of example in the drawings and have been described in detail herein. However, it should be understood that the disclosure is not intended to be limited to the particular forms disclosed. The disclosure is to cover all modifications, equivalents, and alternatives falling within the spirit and scope of the disclosure as defined by the following appended claims.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

### Example Embodiments

EXAMPLE EMBODIMENT 1. An integrated circuit device, comprising:
a programmable logic fabric configured to implement:
   software-defined vector engines; and
   a data movement engine (DME) that uses a plurality of DME threads to programmably insert data within an interior of the software-defined vector engines.

EXAMPLE EMBODIMENT 2. The integrated circuit device of example embodiment 1, wherein the software-defined vector engines comprise a plurality of input registers configured to receive input values for processing in the software-defined vector engines, wherein programmably inserting the data within the interior of the software-defined vector engines comprises inserting the data within the interior comprises bypassing the plurality of input registers.

EXAMPLE EMBODIMENT 3. The integrated circuit device of example embodiment 1, wherein the software-defined vector engines comprise a plurality of output registers.

EXAMPLE EMBODIMENT 4. The integrated circuit device of example embodiment 1, wherein the software-defined vector engines comprise an arithmetic logic unit configured to perform an arithmetic function on input values in input registers.

EXAMPLE EMBODIMENT 5. The integrated circuit device of example embodiment 4, wherein the software-defined vector engines comprise a multiplexer configured to programmably select between an output of the arithmetic function and the inserted data.

EXAMPLE EMBODIMENT 6. The integrated circuit device of example embodiment 5, wherein the arithmetic function comprises addition or subtraction.

EXAMPLE EMBODIMENT 7. The integrated circuit device of example embodiment 5, wherein the software-defined vector engines comprise a plurality of intermediate registers configured to store the output and the inserted data.

EXAMPLE EMBODIMENT 8. The integrated circuit device of example embodiment 7, wherein the software-defined vector engines comprise a multiplier coupled to the multiplexer and configured to receive the output or the inserted data based on the programmable selection.

EXAMPLE EMBODIMENT 9. The integrated circuit device of example embodiment 7, wherein the DME comprises a plurality of DME threads configured to programmably insert data into the plurality of intermediate registers or output registers.

EXAMPLE EMBODIMENT 10. The integrated circuit device of example embodiment 9, wherein the DME comprises a plurality of DME threads configured to programmably insert data into the input registers.

EXAMPLE EMBODIMENT 11. The integrated circuit device of example embodiment 10, wherein the DME comprises a selection DME thread configured to programmably control the selection of the multiplexer.

EXAMPLE EMBODIMENT 12. A programmable logic device, comprising:
a first vector engine implemented in a programmable fabric of the programmable logic device, wherein the first vector engine comprises:
first input registers configured to receive first input values to the first vector engine;
a first arithmetic operator configured to perform an arithmetic operation on the first input values;
first intermediate registers configured to receive a first output of the first arithmetic operator;
a first set of multiplexers configured to select between the first output or other values stored in the first intermediate registers; and
a first multiplier configured to perform a multiplication on values selected using the first set of multiplexers; and
a first data movement engine configured to programmably inject data into the first input registers and the first intermediate registers and configured to program the first set of multiplexers to control the selection between the first output and the other values stored in the first intermediate registers.

EXAMPLE EMBODIMENT 13. The programmable logic device of example embodiment 12, wherein the first vector engine comprises first output registers configured to receive and store a product from the first multiplier.

EXAMPLE EMBODIMENT 14. The programmable logic device of example embodiment 13, wherein the first data movement engine is configured to programmably inject data into the first output registers.

EXAMPLE EMBODIMENT 15. The programmable logic device of example embodiment 12, comprising:
a second vector engine implemented in the programmable fabric, wherein the second vector engine comprises:
second input registers configured to receive second input values to the second vector engine;
a second arithmetic operator configured to perform an arithmetic operation on the second input values;
second intermediate registers configured to receive a second output of the second arithmetic operator;
a second set of multiplexers configured to select between the second output or other values stored in the second intermediate registers; and
a second multiplier configured to perform a multiplication on values selected using the second set of multiplexers; and
   a second data movement engine configured to programmably inject data into the second input registers and the second intermediate registers and configured to program the second set of multiplexers to control the selection between the second output and the other values stored in the second intermediate registers.

EXAMPLE EMBODIMENT 16. The programmable logic device of example embodiment 15, wherein the arithmetic operation of the first arithmetic operator comprises addition or subtraction, and the arithmetic operation of the second arithmetic operator comprises addition or subtraction.

EXAMPLE EMBODIMENT 17. The programmable logic device of example embodiment 16, wherein the arithmetic operation of the first arithmetic operator is different from the arithmetic operation of the second arithmetic operator.

EXAMPLE EMBODIMENT 18. A tangible, non-transitory, and computer-readable medium having stored thereon instructions, that when executed by a processor, are configured to cause the processor to:
generate configuration data for a design to implement a vector engine in a programmable fabric of a programmable logic device, wherein the design comprises:
input registers configured to receive input values to the vector engine;
an arithmetic operator configured to perform an arithmetic operation on the input values;
intermediate registers configured to receive an output of the arithmetic operator;
a set of multiplexers configured to select between the output or other values stored in the intermediate registers;
a multiplier configured to perform a multiplication on values selected using set of multiplexers; and
a data movement engine configured to programmably inject data into the input registers or the intermediate registers and configured to program the set of multiplexers to control the selection between the output and the other values stored in the intermediate registers.

EXAMPLE EMBODIMENT 19. The tangible, non-transitory, and computer-readable medium of example embodiment 18, wherein the instructions, when executed by the processor, are configured to cause the processor to program the data movement engine to decouple an optimized operator implementation of the vector engine using compile time analysis to generate a data movement schedule to be implemented using threads of the data movement engine using microcode.

EXAMPLE EMBODIMENT 20. The tangible, non-transitory, and computer-readable medium of example embodiment 18, wherein the instructions, when executed by the processor, are configured to cause the processor to scale up the vector engine by implementing additional instances of the design.

What is claimed is:

1. An integrated circuit device, comprising:
a programmable logic fabric configured to implement:
software-defined vector engines; and
a data movement engine (DME) that uses a plurality of DME threads to programmably insert data within an interior of the software-defined vector engines.

2. The integrated circuit device of claim 1, wherein the software-defined vector engines comprise a plurality of input registers configured to receive input values for processing in the software-defined vector engines, wherein programmably inserting the data within the interior of the software-defined vector engines comprises inserting the data within the interior comprises bypassing the plurality of input registers.

3. The integrated circuit device of claim 1, wherein the software-defined vector engines comprise a plurality of output registers.

4. The integrated circuit device of claim 1, wherein the software-defined vector engines comprise an arithmetic logic unit configured to perform an arithmetic function on input values in input registers.

5. The integrated circuit device of claim 4, wherein the software-defined vector engines comprise a multiplexer configured to programmably select between an output of the arithmetic function and the inserted data.

6. The integrated circuit device of claim 5, wherein the arithmetic function comprises addition or subtraction.

7. The integrated circuit device of claim 5, wherein the software-defined vector engines comprise a plurality of intermediate registers configured to store the output and the inserted data.

8. The integrated circuit device of claim 7, wherein the software-defined vector engines comprise a multiplier coupled to the multiplexer and configured to receive the output or the inserted data based on the programmable selection.

9. The integrated circuit device of claim 7, wherein the DME comprises a plurality of DME threads configured to programmably insert data into the plurality of intermediate registers or output registers.

10. The integrated circuit device of claim 9, wherein the DME comprises a plurality of DME threads configured to programmably insert data into the input registers.

11. The integrated circuit device of claim 10, wherein the DME comprises a selection DME thread configured to programmably control the selection of the multiplexer.

12. A programmable logic device, comprising:
a first vector engine implemented in a programmable fabric of the programmable logic device, wherein the first vector engine comprises:
first input registers configured to receive first input values to the first vector engine;
a first arithmetic operator configured to perform an arithmetic operation on the first input values;
first intermediate registers configured to receive a first output of the first arithmetic operator;
a first set of multiplexers configured to select between the first output or other values stored in the first intermediate registers; and
a first multiplier configured to perform a multiplication on values selected using the first set of multiplexers; and
a first data movement engine configured to programmably inject data into the first input registers and the first intermediate registers and configured to program the first set of multiplexers to control the selection between the first output and the other values stored in the first intermediate registers.

13. The programmable logic device of claim 12, wherein the first vector engine comprises first output registers configured to receive and store a product from the first multiplier.

14. The programmable logic device of claim 13, wherein the first data movement engine is configured to programmably inject data into the first output registers.

15. The programmable logic device of claim 12, comprising:
a second vector engine implemented in the programmable fabric, wherein the second vector engine comprises:
second input registers configured to receive second input values to the second vector engine;
a second arithmetic operator configured to perform an arithmetic operation on the second input values;
second intermediate registers configured to receive a second output of the second arithmetic operator;
a second set of multiplexers configured to select between the second output or other values stored in the second intermediate registers; and
a second multiplier configured to perform a multiplication on values selected using the second set of multiplexers; and
a second data movement engine configured to programmably inject data into the second input registers and the second intermediate registers and configured to program the second set of multiplexers to control the selection between the second output and the other values stored in the second intermediate registers.

16. The programmable logic device of claim 15, wherein the arithmetic operation of the first arithmetic operator comprises addition or subtraction, and the arithmetic operation of the second arithmetic operator comprises addition or subtraction.

17. The programmable logic device of claim 16, wherein the arithmetic operation of the first arithmetic operator is different from the arithmetic operation of the second arithmetic operator.

18. A tangible, non-transitory, and computer-readable medium having stored thereon instructions, that when executed by a processor, are configured to cause the processor to:
generate configuration data for a design to implement a vector engine in a programmable fabric of a programmable logic device, wherein the design comprises:
input registers configured to receive input values to the vector engine;
an arithmetic operator configured to perform an arithmetic operation on the input values;
intermediate registers configured to receive an output of the arithmetic operator;
a set of multiplexers configured to select between the output or other values stored in the intermediate registers;
a multiplier configured to perform a multiplication on values selected using set of multiplexers; and
a data movement engine configured to programmably inject data into the input registers or the intermediate registers and configured to program the set of multiplexers to control the selection between the output and the other values stored in the intermediate registers.

19. The tangible, non-transitory, and computer-readable medium of claim 18, wherein the instructions, when executed by the processor, are configured to cause the processor to program the data movement engine to decouple an optimized operator implementation of the vector engine using compile time analysis to generate a data movement schedule to be implemented using threads of the data movement engine using microcode.

20. The tangible, non-transitory, and computer-readable medium of claim 18, wherein the instructions, when executed by the processor, are configured to cause the processor to scale up the vector engine by implementing additional instances of the design.
